(19) United States
(12) Patent Application Publication
(10) Pub. No.: US 2010/0294881 A1
(43) Pub. Date: Nov. 25, 2010

(54) Electrolysis system

(76) Inventor: Gary Richard Gochnour, Seattle, WA (US)

Correspondence Address: Gary Richard Gochnour, Apt 426, 747 N. 135th St., Seattle, WA, 98133, US

(21) Appl. No.: 12/661,574

(22) Filed: Mar. 19, 2010

Related U.S. Application Data
(62) Division of application No. 11/728,080, filed on Mar. 23, 2007.
Application No. 11/728,080 is a continuation-in-part of application No. 11/137,643, filed on May 25, 2005, now abandoned.
Application No. 11/137,643 is a continuation-in-part of application No. 10/841,702, filed on May 6, 2004, now abandoned.
(60) Provisional application No. 60/468,598, filed on May 6, 2003.

(51) Int. Cl. B64C 39/00

(52) U.S. Cl. 244/62

(57) ABSTRACT

The invention relates to an electrolysis system. Said system can be utilized in a nuclear fusion process, on roof of a ferromagnetic aircraft in preferred embodiment.

Said electrolysis system will utilize electric energy produced by said aircraft at no cost. Said energy will be provided to an array of electrodes to electrolyze water or seawater to produce protons and electrons, and with B-11 isotope ions, vaporized out of source on board craft, a fusion spherical plasma can be produced on roof of said aircraft, for a nuclear fusion reaction. Stored energy produced by electrolysis system, can also be used for other purposes.

Said fusion spherical plasma is produced at essentially no cost, other than cost of electrolysis system and aircraft.

Three aircraft will be utilized in preferred embodiment, all three craft utilizing an electrolysis system, though only one craft, the ferromagnetic craft alone, producing the B-11 isotope ion.

### CROSS-REFERENCE TO RELATED APPLICATIONS

This application is a division of application Ser. No. 11/728,080 filed Mar. 23, 2007, by present inventor, now abandoned, which was a continuation in part of Ser. No. 11/137,643, filed May 25, 2005 by present inventor, now abandoned, which was a continuation in part of Ser. No. 10/841,702, filed 2004, May 6, by present inventor, now abandoned, which claims the priority to provisional patent application with Ser. No. 60/468,598, filed 2003, May 6, by the present inventor.

### BACKGROUND OF THE INVENTION

Field of Invention—Electrolysis System

This invention relates to an electrolysis system to produce B-11 isotope ions, and H-1 atoms for a nuclear fusion reaction process.

### SUMMARY OF THE INVENTION

In the present invention, an electrolysis system will produce the fuels required for a B-11 isotope ion nuclear fusion reaction.

### BRIEF DESCRIPTION OF THE DRAWINGS

FIG. 5 is a cross section side view showing an electrolysis system.

FIG. 12D is a top plan view of the array of containment barrels and electrodes for electrolysis, and also showing the inner wall and floor for the lower deck.

FIG. 12E is a perspective view from the side of a cutaway view of an array of containment barrels for electrolysis procedure by electrode, and an electrolysis system with an ion acceleration system for exiting particles for formation of fusion spherical plasma.

### DESCRIPTION OF THE PREFERRED EMBODIMENT

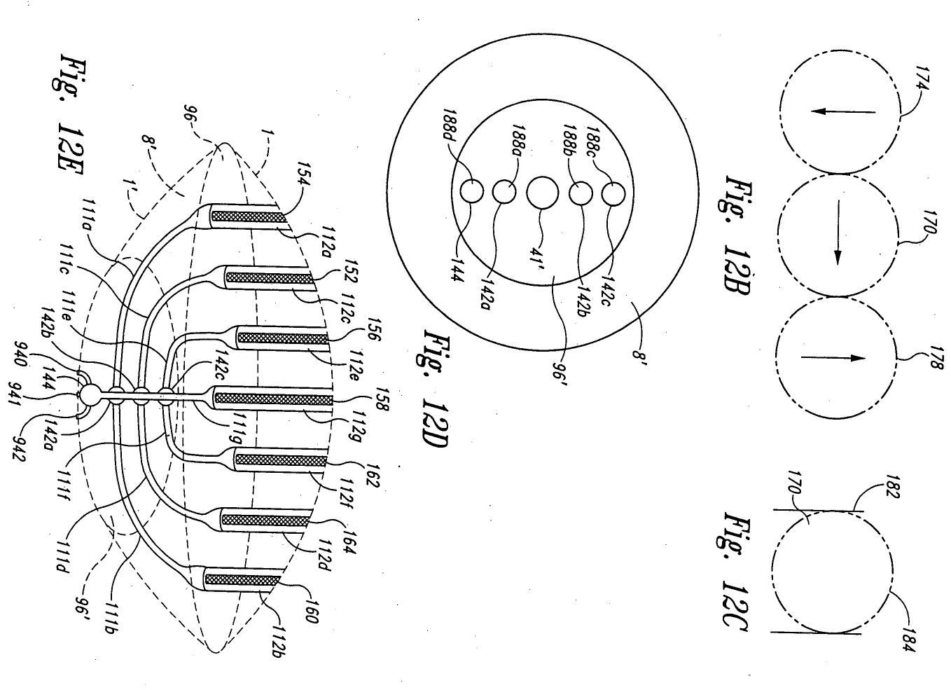

Also within electric system 20, is electrolysis system and electrodes 188a, 188b, 188c, and 188d, FIG. 12D.

An array of ferromagnetic cores within electrolysis system will increase in magnetic intensity due to electrolysis electrodes producing orbiting electrons and particles. During a fusion process, the requirement for energized particles to be placed into mini-Larmor orbits around said ferromagnetic cores within the electrolysis system, will require, after initial formation of orbiting mini-Larmor particle fields, that the particles, primarily protons, electrons and B-11 isotope ions, have to be maintained in orbit around the ferromagnetic cores, increasing magnetic intensity of cores, and particles, as well.

At the onset of the fusion process, the cores will have increased in magnetic intensity to permit formation of the mini-Larmor orbits that will persist after the charged particles exit from roof of aircraft. The orbiting particle miniature funnels, will decompose, and the spiraling, exiting particles will coalesce into a spherical plasma, on roof of the aircraft.

Said electromagnetic systems will be accompanied by plasma systems operating concurrently, said plasma systems include: The plasma produced by internal electrolysis system FIG. 12E producing ions and also electrons.

### END OF DESCRIPTION OF THE PREFERRED EMBODIMENT

Beginning of the Operation of the Process Portion of the Patent The following is a description of the preferred embodiment for operation of process portion.

A brine solution will be used in vaporization process involving seawater. A boric acid solution will be used in vaporization process using borax to obtain the B-11 isotope ion for said nuclear fusion reaction.

By means of an on-board electrolysis system FIGS. 12D and 12E, a boron B-11 isotope fusion spherical plasma can be formed on roof of the smaller ferromagnetic aircraft.

Referring to FIGS. 12D and 12E, depicted are elements of the fusion process utilizing apparatus for an electrolysis system. Said apparatus includes barrel shaped containers for boron B-11 isotope ions 144, FIG. 12D. Said barrel 144 of B-11 isotope ions is connected to tubular column 111g.

Laminated glass is preferred embodiment for tubular columns. The B-11 isotope ion tubular column 111g, FIG. 12E, is connected at one end to ferromagnetic cored column within a larger B-11 ion tubular column 112g, FIG. 12E. Said ferromagnetic column is connected at the other end to exit electrode 158, FIG. 12E. Said electrode also called roof electrode.

Said B-11 isotope ion will exit roof electrode 158, FIG. 12E, at insulated electrode 158, having been placed into mini-Larmor gyro orbits around said ferromagnetic cored column prior to exiting electrode.

Said particle has been energized while rotating around said ferromagnetic column, and this has not diminished the magnetism of said ferromagnetic column, it has increased the magnetism of the cored column, as well.

Barrel 144, FIGS. 12D and 12E, alone contains the fusion fuel boron B-11 isotope ion. Said isotope ion can be vaporized out of source prior to electrolysis procedure, or the B-11 isotope ion can be vaporized out of source on board said aircraft. The source being a brine solution from seawater, containing boron in the seawater or boric acid solution from borax from tincal from deposits in California or other parts of the world.

The remaining fuel source for the fusion reaction will be electrolyzed out of water or seawater, most likely on board said aircraft. The remaining fuel source will be for the H-1 atom; protons and electrons, and with the B-11 isotope ion, forming the fuel elements for the fusion process.

Said electrolysis system is best seen in FIG. 12E. The referenced containment barrels for B-11 fuels for the fusion process, are best seen in FIG. 12D, barrel 142a, 142b, 142c and 144. Though, said barrels are also shown in FIG. 12E.

The maximum current to decompose said fuel solutions completely, to resulting particles desired, being protons, electrons, and the B-11 isotope ion, will be accomplished by two separate procedures, vaporization and electrolysis, can be accomplished on board the aircraft. Water for electrolysis is stored in barrel shaped containers. Platinum electrode is preferred material for electrolysis. Said electrolysis apparatus has what appears to be two arms, columns, on each side of individual barrels, except for said B-11 isotope ion column, which has an individual arm, column, projecting straight upward. The three barrels 142a, 142b and 142c, FIG. 12D, contain water, H2O. Said barrels of water will be electrolyzed by electrodes in FIG. 12D. The B-11 isotope ion will be vaporized out of source, a boron source. Either boric acid from borax from tincal, or boron from a seawater source, a brine from seawater. Oppositely charged particles will exit each barrel, positive on one side, negative on opposite side. Though not the same side on all barrels. The B-11 isotope ion column will extend straight upward.

Sources for boron B-11 isotope ion includes seawater or borax. Borax is a compound found in nature as tincal. Tincal is available in millions of tons, over 200 million in California, a half billion in Turkey. It is also found in Tibet and many other countries of the world to include Russia. For the radiation free and direct conversion to electricity fusion reaction, boron B-11 isotope ion is required, uniquely. The hydrogen atom, H-1, is also required (H+plus e−). The H-1 atom can be obtained from the electrolysis of water. Said tubular columns are also called tubes.

No fusion reaction is radiation free, the B-11 fusion reaction is conventionally referred to as a radiation free reaction. There is no significant radiation produced, or coaling required, using the fuels boron B-11 isotope and regular hydrogen. Energetic charged particles will be produced and stored within vortices.

Barrel 142a, FIG. 12D and 12E, contains a solution of H2O, water, for electrolysis by electrode. Said barrel is connected on one side to tubular column 111a. Said column is connected at the other end to ferromagnetic cored column within a column 112a. Said ferromagnetic column 112a is connected at the other end to exit electrode 154, FIG. 12E. On the other side of said barrel 142a, said barrel is connected to tubular column 111b. Said column 111b is connected at the other end to ferromagnetic cored column within column 112b. Said ferromagnetic column is connected at the other end to exit electrode 160, FIG. 12E.

Barrel 142b containing water for electrolysis by electrode 188, FIG. 12D, is best seen in FIGS. 12D and 12E. In FIG. 12E, on one side of barrel 142b, said barrel is connected to tubular column 111c. Said column is connected at the other end to ferromagnetic cored column 112c. Said ferromagnetic column is connected at the other end to exit electrode 152, FIG. 12E. Barrel 142b, containing water, is shown in FIGS. 12D and 12E, on the other side of barrel 142b, said barrel is connected to tubular column 111d. Said column is connected at the other end of column 111d to ferromagnetic cored column within a larger column 112d. Said ferromagnetic cored column is connected at the other end to exit electrode 164, FIG. 12E.

Barrel 142c, containing water for electrolysis by electrode 188, is shown in FIGS. 12D, and 12E. On one side of barrel 142c, said barrel is connected to tubular column 111e. Said column 111e, is connected at the other end to ferromagnetic cored column within a larger column 112e. Said ferromagnetic cored column is connected at the other end to exit electrode 156, FIG. 12E. Said barrel 142c containing water, is shown in FIGS. 12D and 12E. Oh the the other side of barrel 142c, said barrel is connected to tubular column 111f. Said column 111f is connected at the other end to ferromagnetic cored column 112f. Said ferromagnetic column is connected at the other end to exit electrode 162, FIG. 12E.

The 11 in B-11 isotope ion is the neutrons, and, five protons, the correct designation for this isotope would be ¹¹boron. Conventionally, it is called B-11 isotope, or B-11. The hydrogen atom is one proton and one electron. It is referred to as H or H−1. The ion H+, a proton, is also the hydrogen atom, H−1, without an electron. The terms B-11, H−1, and H+ will be utilized.

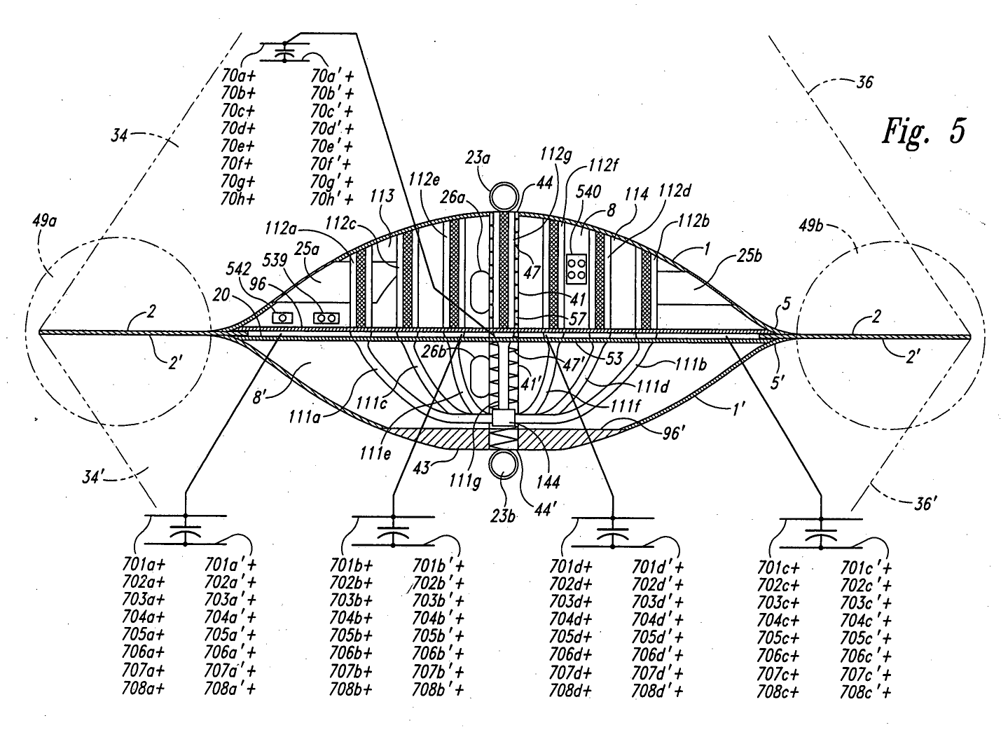

Referring to FIG. 5, a cross section side view is shown. A barrel shaped container of prepared B-11 isotope ion 144 is depicted in FIG. 5. Said barrel shaped container is attached at one end to B-11 isotope ion tubular column 11g, and at the other end of column 111g, said column is attached to a ferromagnetic cored column within a larger tubular column 112g. Preferred embodiment for the bottom tubular column 111g, is laminated, translucent shock and fracture resistant glass. For upper ferromagnetic column 112g, preferred embodiment for glass, is the same fracture and shock resistant, translucent laminated glass. Said column 112g, is connected at the higher end to exit electrode 158. The barrel 144, contains isotope ion solution, said solution is a seawater brine, or boric acid, or other B-11 isotope containing solution. Said electrolysis system is best seen in FIGS. 12D and 12E.

Referring to FIG. 12D, shown is a top view of barrels of water 142a, 142b, and 142c, also shown is a barrel shaped container of solution for B-11 isotope ion evaporation process in barrel 144, FIG. 12D. Shown within containers for electrolysis and vaporization process, are electrodes 188a, 188b, 188c, and 188d, FIG. 12D. Shown in the middle of said array of barrel shaped containers, is central shaft 41′, FIG. 12D and FIG. 5. The bottom deck, octogonal shaped interior wall structure 8′, FIG. 12D, is best seen in FIG. 5. The shape is octogonal pieces in a general beehive configuration, the bottom half of a beehive. The top half of said beehive configured interior, would be the upper one half of aircraft, the upper half of a beehive.

Said shape formed from octogonal pieces, was found by Buckminster Fuller from patterns found in nature, specifically, a beehive, and is the strongest structural frame shape known.

Referring to FIG. 12E, said electrolysis system, FIGS. 12D and 12E, is shown. Depicted in FIG. 12E, is a view of said containers 142a, 142b, 142c, and 144. Said containers attached to indicated columns in FIG. 12E, provides a complete view of said electrolysis system for said large and small aircraft. Said electrolysis system includes electrode system FIG. 12E, ferromagnetic cored columns within larger tubular columns, small columns, and electrode apertures 152, 154, 156, 158, 160, 162, and 164. Vaporization nozzles 940, 941, and 942, are depicted below barrel 144, FIG. 12E, for exhaust gases from vaporization process.

Said column 111g is attached at the other end to a ferromagnetic cored column within a larger tubular column 112g. Preferred embodiment for said column is translucent laminated glass. Said glass is fracture and shock resistant, in preferred embodiment. Said column 112g is connected at the higher end to exit electrode 158, FIG. 12E. The remaining barrels depicted in FIG. 12E utilize water, H2O, as fuel far electrolysis. Barrel 144, alone, utilizes boron B-11 isotope ion, previously vaporized out of source, the preferred embodiment. Said source being seawater or borax from tincal. Other sources are available as well. Barrel shaped container is preferred embodiment for barrels. Electrode 188d is used with barrel 144, FIG. 12E.

The bottom of column 111a, FIG. 12E, is connected to barrel 142 for electrolysis by electrode 188a, FIG. 12D. The other end of column 111a, is connected to ferromagnetic cored column within a larger tubular column 112a. Said column 112a is connected at the other end to exit electrode 154. Tubular column 111b is connected to said barrel 142a, FIG. 12E, on the other side of said barrel. Tubular column 111b is connected at the other end to ferromagnetic cored column, within a larger tubular column 112b. Said ferromagnetic cored column 112b, is connected at the other end to exit electrode 160, FIG. 12E. The particle emanating from electrode aperture 160 is a negative particle, an electron. Said column utilizes electrolysis electrode 188a, FIG. 12E.

The bottom of tubular column 111c, FIG. 12E, is connected to barrel 142b for electrolysis by electrode 188b, FIG. 12E. The other end of said column 111c is connected to ferromagnetic cored column, within a larger tubular column 112c. Said ferromagnetic cored column 112c is connected at a higher end to exit electrode 152, FIG. 12E. The particle emanating from said electrode opening, is a negative particle, an electron. On the other side of said barrel 142b, column 111d is connected to said barrel. The other end of said column 111d is connected to ferromagnetic cored column, within a larger tubular column 112d. Said ferromagnetic column is connected at a higher end to exit electrode 164, FIG. 12E. The particle emanating from said electrode is a positive particle, a positive proton, column 111d is connected to barrel 142b for electrolysis by electrode 188b, FIG. 12D.

The bottom of column 111e is connected to barrel 142c, FIG. 12E, for electrolysis by electrode 188c, FIG. 12D. The other end of said column is connected to ferromagnetic cored column, within a larger tubular column 112e. Said ferromagnetic column 112e, is connected at a higher end to exit electrode 156, FIG. 12E. The particle emanating from electrode 156 is a positive particle, a positive proton. On the other side of said barrel 142c, FIG. 12E, tubular column 111f is connected to said barrel 142c. The other end of said column 111f is connected to ferromagnetic cored column within a larger tubular column 112f. Said ferromagnetic cored column, within a larger tubular column 112f. Said ferromagnetic cored column 112f, is connected at the other end to exit electrode 162, FIG. 12E. The particle emanating from said electrode 162 is a negative particle, an electron.

1. An electrolysis system, FIG. 12E, within said craft comprising barrel shaped containers of water, a container of boron B-11 isotope ion solution, electrode to electrolyze said water, a system for vaporization to obtain said B-11 isotope ion from borax, preferred source, seawater is also a recommended source, a method to accelerate ions in said electrolysis system prior to said ions exiting roof electrodes on top of said aircraft, FIG. 12E, said ions will exit funnel shaped spirals within an induced magnetic field formed on roof of said aircraft, a method for forming said induced magnetic field, wherein said exiting particles from said electrolysis system will form into a fusion spherical plasma on roof of said aircraft, within a tightening induced Larmor orbiting particle field, a method for forming said induced Larmor orbiting particle field, and a method whereby said fusion spherical plasma can be formed by said particles exiting at correct electrode exits on roof of aircraft to obtain correct opposing charge combinations.

2. The method of claim 1, wherein a method for forming said induced Larmor orbiting particle fields comprises,
(a) raising said pyramid shaped column with a glass ball electrode on top, whereby,
(b) an induced magnetic field is formed on top of said ferromagnetic aircraft, or other diamagnetic aircraft, wherein,
(c) an induced Larmor orbiting particle field around said fusion spherical plasma is also formed, said induced Larmor orbiting particle field is within said induced magnetic field.

3. The method of claim 1, wherein said exiting particles from said electrolysis system onto roof of said aircraft, form into a fusion spherical plasma within,
(a) an induced Larmor orbiting particle field, within
(b) an induced magnetic field, within a larger applied magnetic field, and,
(c) an induced electric current within an induced electric field, and also existing along with said fields, an,
(d) expanded magnetic field, and an, expanded electric field, with an,
(e) expanded electric current with the expanded electric field, said expanded electric current cutting the fusion spherical plasma at its midpoint, said
(f) expanded electric current is, in effect, uplifted to the center, and around said fusion spherical plasma.

4. The method of claim 1, wherein a method of forming a fusion spherical plasma on the roof of said aircraft, by means of said electrolysis system within an induced magnetic field, within an induced Larmor orbiting particle field, comprises,
(a) projecting exiting particles through electrode apertures on roof of said aircraft as depicted in FIG. 12E, as opposed,
(b) to assumed particle exits as depicted in FIG. 12E, due to,
(c) requirement for opposing charge combinations for exiting particles through said electrode apertures to be, exiting particles at electrode 154 are of a positive charge, exiting particles at electrode 158, the B-11 isotope ion exit, are positive and exiting particles at exit electrode 164 are positive, the resulting repulsive force will isolate the B-11 isotope ion, and repel positive particle in electrode 154 to combine with negaticle in electrode 152, a positive particle in electrode 164 to combine with negative particle in electrode 160, said two non-identified electrodes heretofore in this description, electrode 162 and 156 will also combine, said successful combinations are due to final physical crossing of tubular exits as shown in FIG. 12E to those as shown in FIG. 12E, showing successful combinations,
(b) whereby, said particles will form into said fusion spherical plasma within said induced magnetic field, within said induced Larmor orbiting particle field.

5. The electrolysis system as defined in claim 1, wherein said smaller and larger columns are both comprised of the material translucent, shock and fracture resistant, laminated glass.

6. The electrolysis system as defined in claim 1, wherein said electrolysis electrodes are comprised of the material platinum, for decomposing by electrolysis.

7. The method of claim 1, wherein a method for accelerating said particles within said large tubular columns comprises,
(a) rotating said particles around a ferromagnetic core, within a larger tubular column, thereby,
(b) energizing said ferromagnetic core, and,
(c) increasingly accelerating said particles simultaneously.
